(19) United States
(12) Patent Application Publication
(10) Pub. No.: US 2006/0161752 A1
(43) Pub. Date: Jul. 20, 2006

(54) Method, apparatus and program storage device for providing adaptive, attribute driven, closed-loop storage management configuration and control

(76) Inventor: Todd R. Burkey, Savage, MN (US)

Correspondence Address: CRAWFORD MAUNU PLLC, 1270 NORTHLAND DRIVE, SUITE 390, ST. PAUL, MN, 55120, US

(21) Appl. No.: 11/037,404

(22) Filed: Jan. 18, 2005

(51) Int. Cl. G06F 12/00

(52) U.S. Cl. 711/170

(57) ABSTRACT

A method, apparatus and program storage device for providing adaptive, attribute driven, closed-loop storage management configuration and control is disclosed. The closed loop control mechanism provides not only continuous self-tuning to the storage system, but also allows the system to perform the initial configuration better.

### BACKGROUND OF THE INVENTION

1. Field of the Invention

This invention relates in general to storage systems, and more particularly to a method, apparatus and program storage device for providing adaptive, attribute driven, closed-loop storage management configuration and control.

2. Description of Related Art

A computer network is a connection of points (e.g., a plurality of computers) that have been interconnected by a series of communication paths. Moreover, any number of individual computer networks may be interconnected with other computer networks, which may increase the complexity of the overall system. Generally, computer networks may be used to increase the productivity of those computers that are connected to the network. The interconnection of the various points on the computer network may be accomplished using a variety of known topologies. Generally, a host computer (e.g., server) may function as a centralized point on the network. For example, using any of the network topologies discussed above, a plurality of client computers may be interconnected such that the server controls the movement of data across the network. The host computer may have an operating system that may be used to execute a server application program that is adapted to support multiple clients. Typically, the server may service requests from a plurality of client computers that are connected to the network. Furthermore, the server may be used to administer the network. For example, the server may be used to update user profiles, establish user permissions, and allocate space on the server for a plurality of clients connected to the network.

In many computer networks, a large amount of data may be stored on the server and accessed by the attached client computers. For example, each client computer may be assigned a variable amount of storage space on a server. The administration of a storage system is often a complex task that requires a great deal of software and hardware knowledge on the part of the administrator. Given a pool of storage resources and a workload, an administrator must determine how to automatically choose storage devices, determine the appropriate device configurations, and assign the workload to the configured storage. These tasks are challenging, because the large number of design choices may interact with each other in poorly understood ways.

The explosion of data created by e-business is making storage a strategic investment priority for companies of all sizes. As storage takes precedence concern for business continuity and business efficiency have developed. Two new trends in storage are helping to drive new investments. First, companies are searching for more ways to efficiently manage expanding volumes of data and make that data accessible throughout the enterprise. This is propelling the move of storage into the network. Second, the increasing complexity of managing large numbers of storage devices and vast amounts of data is driving greater business value into software and services. A Storage Area Network (SAN) is a high-speed network that allows the establishment of direct connections between storage devices and processors (servers) within the distance supported by Fibre Channel. SANs are the leading storage infrastructure for the world of e-business. SANs offer simplified storage management, scalability, flexibility, availability, and improved data access, movement, and backup.

An organization considering implementing a SAN faces a number of challenges. These challenges may include: designing the SAN, communicating the SAN design to interested parties, installing the SAN and managing changes to the SAN after installation. The first-and often the most complex-step for deploying a SAN is determining a proper design and configuration to meet a user's needs. The complexities associated with SANs often revolve around how a SAN is incorporated within a storage system, how the SAN works with individual storage components, and how to design the overall topology of the SAN. SANs are often designed with pencil and paper. For more complex SAN configurations, such a technique is inadequate, inviting errors and miscalculations. Further, users are often faced with the daunting task of determining which components are needed for a new or modified SAN and how to configure these components so they will work with existing components and cabling.

Configuring storage area networks, even at the enterprise scale, is traditionally undertaken by human experts using a time-consuming process of trial and error, guided by simple rules. The Information Technology (IT) departments that operate SANs are often hampered by complex SAN topologies and configurations—leading to increased management costs. Additionally, IT departments face challenges due to the scarcity of highly trained personnel as well as the need for rapid deployment of SANs. Additionally, IT environments that often experience human resources turnover due to industry wide competition influence the ongoing operation of a SAN. As a result, when an employee departs from an organization, that organization often loses an important source of technical knowledge.

When configuring a storage system, users take a best guess at the appropriate configuration options including creating LUNs on a storage system to provide adequate performance and redundancy. Improper configuration raises the risk of a system becoming so slow that it becomes a problem that has to be resolved after the fact. Users and/or tools are used to monitor the performance to determine what is needed to rectify underperformance. Corrective action is manually taken to correct the problem up to and including recreating storage configurations and re-installing operating systems and backups. As storage systems get more complex, the concept of a user making the correct initial choices for storage configuration or being able to balance all the factors correctly when analyzing the storage performance is virtually impossible if the desire is to achieve peak performance of a storage system.

In fact, as systems get increasingly complex, a minor adjustment by the user in one area of the storage system to improve performance can cause an extreme swing in degraded performance in other areas of the system. Successive iterative approaches to performance tuning may then be necessary to correct the storage system performance and achieve an acceptable balance. In the mechanical engineering world, this affect would be corrected via a closed loop control system (i.e. a PID loop) to provide quick damping of oscillations and to actually prevent them from occurring in the first place . . . in much the same way that will be presented in the context of this invention to solve this ‘iterative’ approach in the storage world.

It can be seen then that there is a need for a method, apparatus and program storage device for providing adaptive, attribute driven, closed-loop storage management configuration and control.

### SUMMARY OF THE INVENTION

To overcome the limitations in the prior art described above, and to overcome other limitations that will become apparent upon reading and understanding the present specification, the present invention discloses a method, apparatus and program storage device for providing adaptive, attribute driven, closed-loop storage management configuration and control.

The present invention solves the above-described problems by providing a closed loop control mechanism that provides not only continuous self-tuning to the storage system, but also allows the system to perform the initial configuration better. Speed, less user complexity and better performance are provided in a proactive solution.

A method in accordance with the principles of the present invention includes monitoring at least one storage cluster for adherence to predetermined objectives and controlling virtual disks and virtual links associated with at least one storage cluster in response to the monitoring.

In another embodiment of the present invention, a closed-loop storage system is provided. The closed-loop storage system includes an interface for providing a virtual view into at least one storage cluster to facilitate management and modification to configurations of the at least one storage cluster, a monitoring and feedback device, coupled to the interface, for monitoring the at least one storage cluster for adherence to predetermined objectives, and a configuration and control device, coupled to the monitoring and feedback device, for controlling virtual disks and virtual links associated with the at least one storage cluster in response to input from the monitoring and feedback device.

In another embodiment of the present invention, a program storage device is provided. The program storage device includes program instructions executable by a processing device to perform operations for providing a closed-loop storage system, the operations include monitoring at least one cluster for adherence to predetermined objectives and controlling virtual disks and virtual links associated with the at least one storage cluster in response to the monitoring.

In another embodiment of the present invention, another closed loop storage system is provided. This closed loop storage system includes means for providing a virtual view into at least one storage cluster to facilitate management and modification to configurations of the at least one storage cluster, means, coupled to the means for providing a virtual view, for monitoring the at least one storage cluster for adherence to predetermined objectives and means, coupled to the means for monitoring, for controlling virtual disks and virtual links associated with the at least one storage cluster in response to input from the monitoring and feedback device.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage system;

FIG. 2 illustrates a system for providing adaptive, attribute driven storage according to an embodiment of the present invention;

FIG. 3 illustrates adaptive, attribute driven, closed-loop storage management configuration and control based upon performances parameters according to an embodiment of the present invention; and

FIG. 4 is a flow chart of the method for providing adaptive, attribute driven, closed-loop storage management configuration and control according to an embodiment of the invention; and

FIG. 5 illustrates a storage management configurator according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides method, apparatus and program storage device for providing adaptive, attribute driven, closed-loop storage management configuration and control. The present invention provides a closed loop control mechanism that provides not only continuous self-tuning to the storage system, but also allows the system to perform the initial configuration better. Speed, less user complexity and better performance are provided in a proactive solution.

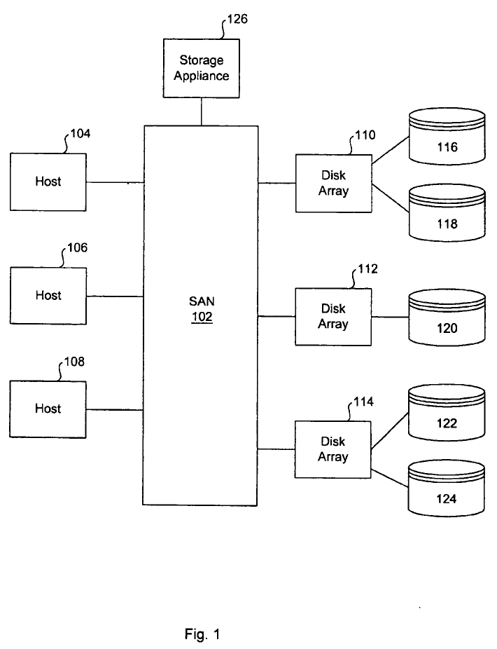

FIG. 1 illustrates a storage system 100. In FIG. 1, a storage area network 102 provides a set of hosts (e.g., servers or workstations) 104, 106, 108 that may be coupled to a pool of storage devices (e.g., disks). In SCSI parlance, the hosts may be viewed as “initiators” and the storage devices may be viewed as “targets.” A storage pool may be implemented, for example, through a set of storage arrays or disk arrays 110, 112, 114. Each disk array 110, 112, 114 further correspond to a set of disks. In this example, first disk array 110 corresponds to disks 116, 118, second disk array 112 corresponds to disk 120, and third disk array 114 corresponds to disks 122, 124. Rather than enabling all hosts 104-108 to access all disks 116-124, it is desirable to enable the dynamic and invisible allocation of storage (e.g., disks) to each of the hosts 104-108 via the disk arrays 110, 112, 114. In other words, physical memory (e.g., physical disks) may be allocated through the concept of virtual memory (e.g., virtual disks). This allows one to connect heterogeneous initiators to a distributed, heterogeneous set of targets (storage pool) in a manner enabling the dynamic and transparent allocation of storage.

The concept of virtual memory has traditionally been used to enable physical memory to be virtualized through the translation between physical addresses in physical memory and virtual addresses in virtual memory. Recently, the concept of “virtualization” has been implemented in storage area networks through various mechanisms. Virtualization converts physical storage and virtual storage on a storage network. The hosts (initiators) see virtual disks as targets. The virtual disks represent available physical storage in a defined but somewhat flexible manner. Virtualization provides hosts with a representation of available physical storage that is not constrained by certain physical arrangements/allocation of the storage.

One early technique, Redundant Array of Independent Disks (RAID), provides some limited features of virtualization. Various RAID subtypes have been implemented. In RAID1, a virtual disk may correspond to two physical disks 116, 118 which both store the same data (or otherwise support recovery of the same data), thereby enabling redundancy to be supported within a storage area network. In RAID0, a single virtual disk is striped across multiple physical disks. Some other types of virtualization include concatenation, sparing, etc. Some aspects of virtualization have recently been achieved through implementing the virtualization function in various locations within the storage area network. Three such locations have gained some level of acceptance: virtualization in the hosts (e.g., 104-108), virtualization in the disk arrays or storage arrays (e.g., 110-114), and virtualization in a storage appliance 126 separate from the hosts and storage pool. Unfortunately, each of these implementation schemes has undesirable performance limitations.

Virtualization in the storage array involves the creation of virtual volumes over the storage space of a specific storage subsystem (e.g., disk array). Creating virtual volumes at the storage subsystem level provides host independence, since virtualization of the storage pool is invisible to the hosts. In addition, virtualization at the storage system level enables optimization of data access and therefore high performance. However, such a virtualization scheme typically will allow a uniform management structure only for a homogenous storage environment and even then only with limited flexibility. Further, since virtualization is performed at the storage subsystem level, the physical-virtual limitations set at the storage subsystem level are imposed on all hosts in the storage area network. Moreover, each storage subsystem (or disk array) is managed independently. Virtualization at the storage level therefore rarely allows a virtual volume to span over multiple storage subsystems (e.g., disk arrays), thus limiting the scalability of the storage-based approach.

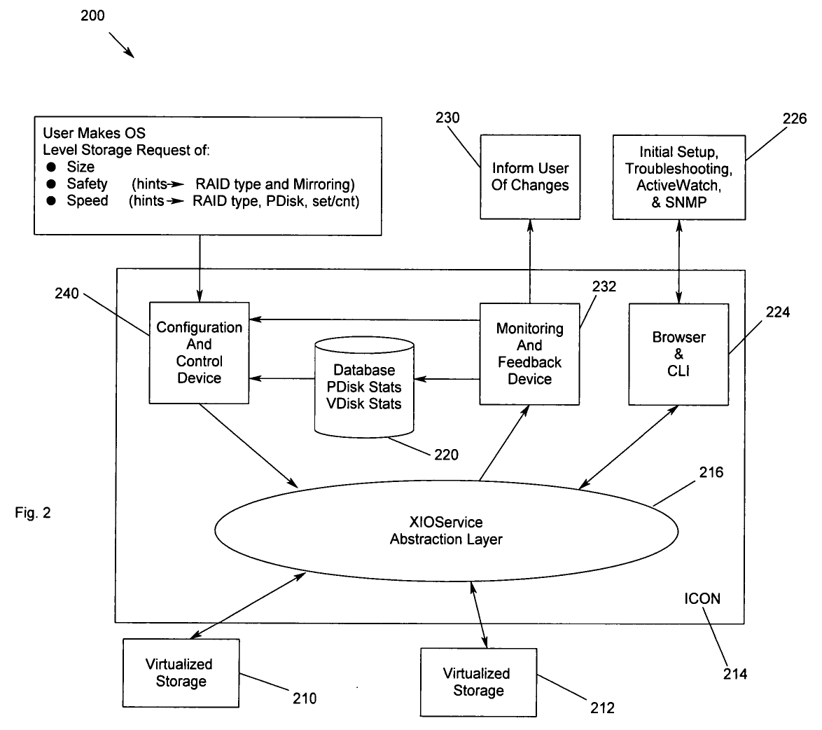

FIG. 2 illustrates a system 200 for providing adaptive, attribute driven storage according to an embodiment of the present invention. In FIG. 2, virtualized storage 210, 212 are controlled by an intelligent control management platform 214. The intelligent control management platform 214 manages all accessible clusters of storage space of the virtualized storage 210, 212. The intelligent control management platform 214 offers complete monitoring of backbone devices and provides a common tool to detect and anticipate storage outages. Statistics are profiled in a database 220. The statistics include physical disk (Pdisk) and virtual disk (Vdisk) statistics on asset, CPU and host connection performance, and storage array structural information that allows quick and easy identification of problems.

The intelligent control management platform 214 uses an abstraction layer 216 to mask physical cluster complexity and empower storage control. The intelligent control management platform 214 includes a browser-based dimensional interface 224 that provides a virtual view into the cluster to facilitate high level management, troubleshooting, and modification to storage configurations. At this level, the user will typically have the ability to create storage via hints and generalizations as to which storage pools and controllers to use, but much of the complexity will be hidden from the user (i.e. the user will never be required to specify exactly which physical disks to use in a raid array or worry about manually ensuring bus or bay redundancy.) Thus, the intelligent control management platform 214 eliminates the need for expensive and highly trained specialists to manage and adapt storage.

Users are informed of changes 230 in performance and configuration of a system through the monitoring and feedback device 232. The monitoring and feedback device 232 monitors VDisks to validate hint adherence, to initiate feedback reconfiguration for restripes and priority changes and to verify closed-loop changes. This closed loop control technique provided by the intelligent control management platform 214 in conjunction with the monitoring and feedback device 232 and a configuration and control device 240 allows the user to be removed from the decision process in configuring the storage systems, except for the hints or attributes the user may assign to storage entities such as LUNs or switches to better guide the storage system in the initial creation process. The hints and initial attributes merely provide broad objectives or guidelines for the storage clusters. These hints will then be used in conjunction with observed data usage patterns and performance rules to induce dynamic re-adjustment (restriping, changing redundancy levels, moving virtual disks between storage systems via Vlinks, i.e., virtual links, which refers to an object that is treated within a storage array exactly as a VDisk is treated, but in actuality is simply a pointer to a VDisk in another storage array, with no server downtime and little if any user decisions. Both underperformance as well as over-performance adjustments may be made by the system to achieve a properly tuned storage system.

The monitoring and feedback device 232 identifies hotspots on the physical disks, characterizes their performance and may move individual stripes or groups of stripes via smart defragmentation processes. The monitoring and feedback device 232 may thus monitor the aggregate system performance including total throughput and bandwidth and CPU and bus utilization. The user is only presented LUNs (Virtual disks) that have specific characteristics that can be dynamically adjusted. These characteristics can include but are not limited to size, throughput (MB/S) bandwidth (IO/S), redundancy, startup latency (ms), and request latency (ms).

The configuration and control device 240 provides an interface for controlling VDisks and VLinks. For example, the configuration and control device 240 allows VDisks and VLinks to be created, expanded, deleted and/or prioritized. The monitoring and feedback device 232 receives feedback continually from the intelligent control management platform 214 to determine whether the ideal behavior of the system matches the actual behavior.

The configuration and control device 240 is used to define the characteristics of a storage system. Initially, a LUN is given a set of baseline characteristics. As time passes, changes are desired in these characteristics so, if or when practical, the characteristics are changed, i.e., the size may be expanded or the virtual disks may be restriped to acquire new performance metrics.

Sometimes a desire for a virtual disk doesn't match up with what is actually obtained. This can be true from both a size and performance perspective, in both the positive and negative senses as well. For example, initially, a VDisk may be desired to be able to perform 60 MB/Sec. Upon review of the VDisk's actual performance, it may be determined that the VDisk never experiences more than 5 MB/Sec, or maybe just that it needs the 60 MB/Sec for an hour every night while doing backups. In such a scenario, it may be desirable to restripe the VDisk over either slower PDisks, over PDisks that have been set aside for lower performance usage, or over a pool of PDisks that don't experience usage during that hour every night that the VDisk needs high bandwidth, freeing the PDisks that the VDisk was originally striped over for use by VDisks that are truly deserving of higher performance capacity.

Thus, the monitoring and feedback device 232 and the configuration and control device 240 may be used in conjunction with the abstraction layer 216 to classify physical disks into characterized pools and to characterize higher level abstractions that define the performance of virtual disks that are striped over these pools. The higher levels of abstraction provided by the abstraction layer 216 define the performance of virtual disks that are striped over these pools by providing the ability to prioritize one VDisk over another, providing a selection of RAID types and stripe sizes and mirror depths and styles (via VLinks) to achieve performance gradients within a specific pool, providing the ability to dynamically change the RAID characteristics and advanced mirroring functionality that takes advantage of an ability to instantly mirror on VDisk creation and a smart function that allows mirror pause/resume load balancing if so allowed or desired in the redundancy rules.

The monitoring and feedback device 232 and the configuration and control device 240 may be used in conjunction with the abstraction layer 216 to request and retain the user requirements for the creation of a VDisk, to develop an artificial intelligence (AI) engine that takes the user requirements and creates the VDisk automatically based on the user requirements and a knowledge of the current operational dynamics of the storage system. These dynamics include current and time based utilization of each PDisk and each VDisk, current and time based processor utilization and configuration information that relates to redundancy, e.g., bus and VLinked redundancy.

The monitoring and feedback device 232 and the configuration and control device 240 may be used in conjunction with the abstraction layer 216 to develop a feedback mechanism that monitors all VDisk dynamics to see if the actual performance matches the desired, monitor PDisk and host adapter board (HAB) utilization and if possible (and within a hysteresis cycle,) restripe the VDisk in the same or in a different pool class. The monitoring and feedback device 232, the configuration and control device 240 and the abstraction layer 216 may be used to develop a reporting mechanism 230 that keeps the user in the loop of these automatic changes (either via reports or via requests to make a change if the user desires to stay in the loop).

Accordingly, monitoring and feedback device 232, the configuration and control device 240 and the abstraction layer 216 of the intelligent control management platform 214 provides a GUI-less, attribute based and driven storage system. Implemented at a sufficiently high enough level of abstraction, these functions may be implemented with minimal changes to the platform firmware of a virtualized storage system.

Attribute driven storage mechanisms according to an embodiment of the present invention are implemented as two asynchronously running applications of the monitoring and feedback device 232 and the configuration and control device 240 that are clients in the intelligent control management platform 214 of the abstraction layer 216. Other embodiments of this invention may merge the two asynchronously running applications into a single application. The monitoring and feedback device 232 and the configuration and control device 240 can be also be thought of as providing four logical subtasks, i.e., listen, learn, report, and control, each of which will be further discussed in the following paragraphs.

The monitoring and feedback device 232 listens to (gathers data from) both the user and the storage system and stores the information in a persistent database 220. The statistics on the physical disks (PDisks) characterize the base and timebased information on each PDisk. The base information includes data regarding the PDisk such as size, serial number, etc., as well as a type that allows the ranking of PDisks. The timebased information allows tracking of trends such as usage, available performance at specific times, peaks, etc. The timebased information includes some of the PDisk statistics correlated to a specified time frame, such as the hour of the week. Other data includes the speed of the PDisk, the location, how busy the PDisk is supposed to be based on hints given at VDisk creation, how busy is the PDisk at specific times of the day (and overall). Other data may also be monitored.

The monitoring and feedback device 232 gathers statistics on the virtual disks (VDisks) including information on what the baseline hints are currently set to, what the current performance of the VDisk actually is; what the rules for correction are, etc. The monitoring and feedback device 232 also gathers information on each storage unit. The monitoring and feedback device 232 monitors the server WWN's that see each storage unit and which cluster/workset is accessible by those WWN's. Still further, monitoring and feedback device 232 also gathers the name and the WWN/Port# for each server.

Based on the gathered data, the monitoring and feedback device 232 learns, comparing the actual performance against the requested baseline performance. The baseline performance is simply what was requested. The actual performance will be timebased for every hour of the week with peak and mean information tracked.

The user provides hints at initialization 226 to provide an indication of what level of storage is desired. Aside from the basic data on MB/S and IO/S, there are near/far disaster recovery issues, levels of redundancy, common latency (affects cache decisions), retrieval latency (could support spindown drives), etc. Some weighting of the hints can be provided to the configuration and control device 240 to allow preferences to be used when making automatic calculations. For example, weighting may be as simple as informing the system that throughput is more important than bandwidth, i.e., give MB/S preference over IO/S, or as complex as informing the system that the rule applies EXCEPT on Wednesdays when the inverse is true.

The monitoring and feedback device 232 provides reporting to the user to indicate a general performance/state of the system and event notification if changes are auto-initiated or required of user. The monitoring and feedback device 232 also provides internal reporting to build a dataset to drive the configuration and control device 240. The interface between the monitoring and feedback device 232 and the configuration and control device 240 should not be the database defined above. Rather, the interface may be a simple command structure that allows independent development of the two engines.

When the configuration and control device 240 makes changes, the configuration and control device 240 must account for not only the correction operations it makes, but also keep the monitoring and feedback device 232 informed. Thus, the configuration and control device 240 makes corrections, while ensuring that the corrections themselves don't affect the performance decisions made by the monitoring and feedback device 232.

A baseline is the performance of the system as requested by the user or the last correction. The simplest baseline has no history of previous success in meeting requirements. A more complex baseline may keep a prior history. In addition, the configuration and control device 240 allows for user advised corrections. User advised corrections are easy to handle because the user hints will drive a specific set of commands into the configuration and control device 240.

For automatic corrections, trigger levels are determined by the configuration and control device 240 before performance is recalibrated. A timebase is used for determining how long a variation of the triggering magnitude has to exist before an action is implemented. For example, if too short a time is used, the system will never get out of the loop of always correcting and an exact idea of the normal performance characteristics will not be possible. Generally, the dwell period must be at least twice as long as the amount of time the correction itself takes.

The monitoring and feedback device 232 and the configuration and control device 240 work with the intelligent control management platform 214 of the abstraction layer 216 to provide superior strategies in backup, data testing, versioning, and data migration that can be performed any time during the work day, instead of in the middle of the night or on the weekend. In one embodiement of the present invention, however, corrections can be deferred until off peak times for the storage arrays.

Adding new drives to a storage array and then striping across the new drives to improve performance usually means disrupting the server access in many contemporary raid arrays. However, according to embodiments of the present invention, the user is removed from the process. After new drives are installed, the monitoring and feedback device 232 initiates reconfiguration and monitors all changes. The configuration and control device 240 creates a destination VDisk that is at least as large as the source VDisk. The new VDisk stripes data across both the existing and newly installed drives. The source VDisk is then ‘copy/swapped’ to the Destination VDisk. This operation copies the contents of the source VDisk to the destination VDisk. At the instant the copy is completed, the source and the destination VDisks' RAID arrays are swapped, the copy terminates, and server access to the Source VDisk continues uninterrupted (however the Source VDisk now contains the raid arrays that are striped over the old and new PDisks). It is important to know that while copying one drive (source VDisk) to another drive (destination VDisk), the source and destination drives will be synchronized with mirroring so that any writes to the source drive are written in parallel to the destination drive. Thus, the server never sees anything amiss throughout such a process.

The configuration and control device 240 may also change RAID levels on the fly. For example, if a volume at RAID 5 has been set up, but now a RAID 10 needs to be set up to improve performance, copy functions are performed in the background so that the server is never aware of the operation or that it is actually reading and writing to a different RAID level storage volume. To change RAID levels on the fly, a destination VDisk of the exact size as the source VDisk is created, but with a different RAID level (such as RAID 10). The source VDisk is is then ‘copy/swapped’ to the Destination VDisk. This operation copies the contents of the source VDisk to the destination VDisk. At the instant the copy is completed, the source and the destination VDisks' raid arrays are swapped, the copy terminates, and server access to the Source VDisk continues uninterrupted (however the Source VDisk now contains the raid arrays that are Raid 10). It is important to know that while copying one drive (source VDisk) to another drive (destination VDisk), the source and destination drives will be synchronized with mirroring so that any writes to the source drive are written in parallel to the destination drive . . . thus the server never sees anything amiss throughout such a process.

The configuration and control device 240 may also increase capacity across the network storage. If there is not enough capacity on one storage array to increase a VDisk size, the VDisk may be migrated to another storage array and available storage on another storage array may be used.

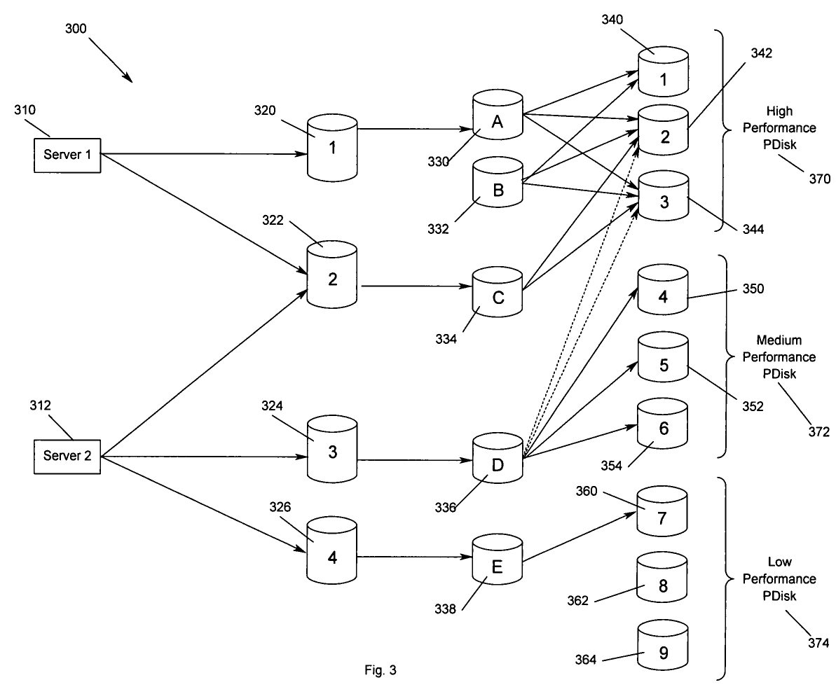

FIG. 3 illustrates a storage system 300 demonstrating adaptive, attribute driven, closed-loop storage management configuration and control based upon performances parameters according to an embodiment of the present invention. In FIG. 3, two servers 310, 212 are shown that are provided with four VDisks 320, 322, 324, 326. Server 1 310 sees VDisk 1 320 and VDisk 2 322. Server 2 sees VDisk 2 322, VDisk 3 324 and VDisk 4 326. Five RAIDs are configured for the VDisks 1-4 320-326. VDisk 1 320 includes RAID A 330 and RAID B 332. VDisk 2 322 includes RAID C 334. VDisk 3 324 includes RAID D 336 and VDisk 4 326 includes RAID E 328.

RAID A 330 is configured over PDisks 1-3 340, 342, 344. RAID B is also configured over PDisks 1-3 340, 342, 344. RAID C 334 is configured over PDisks 2-3 342, 344. RAID D 336 is initially configured over PDisks 2-3 342, 344. RAID E 338 is configured over PDisks 7 360. PDisks 1-3 340-344 are high performance PDisks 370. PDisks 4-6 350,352,354 are medium performance PDisks 372. PDisks 7-9 360, 362, 364 are low performance PDisks 374.

However, the monitoring and feedback device 232 of FIG. 2 observes that VDisk 3 324 is causing a bottleneck to Server 2 312 on PDisk2 342 and PDisk3 344. The monitoring and feedback device 232 of FIG. 2 observes that the I/O rate is medium versus the predicted high. The monitoring and feedback device 232 of FIG. 2 initiates restriping. The configuration and control device 240 of FIG. 2 restripes the data for RAID C over PDisks 4-6 350, 352, 354.

Those skilled in the art will recognize that the present invention is not meant to be limited to the above extremely simple examples. Rather, these examples merely represent a limited set of possible operations that the monitoring and feedback device 232 and configuration and control device 240 in conjunction with the intelligent control management platform 214 of the abstraction layer 216 to provide adaptive, attribute driven, closed-loop storage management configuration and control.

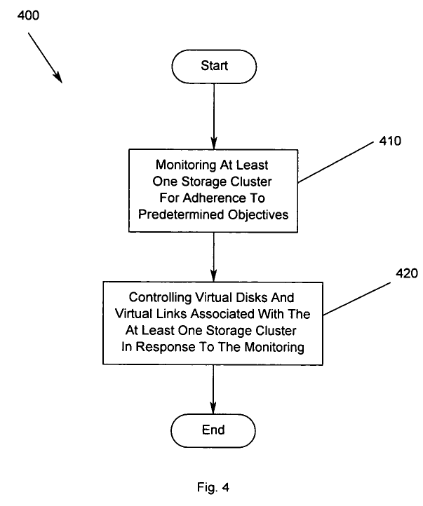

FIG. 4 is a flow chart 400 of the method for providing adaptive, attribute driven, closed-loop storage management configuration and control according to an embodiment of the invention. At least one storage cluster is monitored for adherence to predetermined objectives 410. Virtual disks and virtual links associated with the at least one storage cluster are controlled in response to the monitoring 420. Those skilled in the art will recognize that the method may include additional details explained with reference to FIGS. 2 and 3 above.

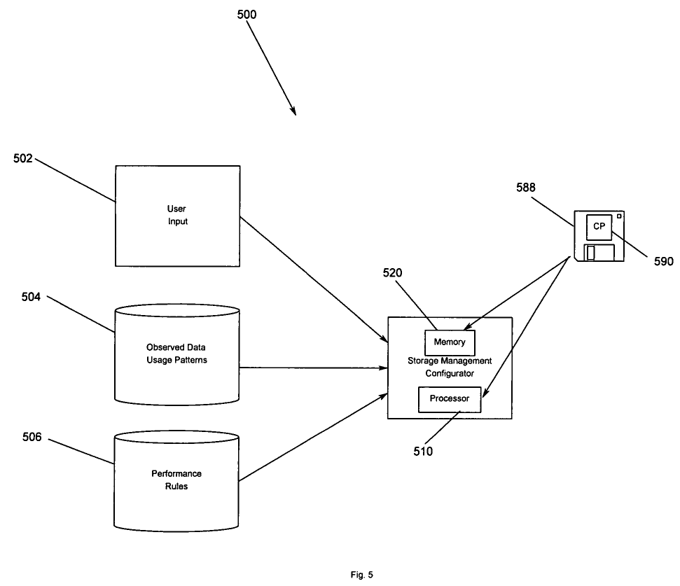

FIG. 5 illustrates a storage management configurator 500 according to an embodiment of the present invention. The storage management configurator 500 provides adaptive, attribute driven, closed loop storage management configuration and control. Closed loop control techniques provided by processor 520 remove the user decision process from the configuration of storage systems. The user may provide hints 540 and/or attributes 542 to storage entities such as LUNs or switches to better guide the storage system in the initial creation process. The user input 502 is used in conjunction with observed data usage patterns 504 and performance rules 506 to induce dynamic re-adjustment (restriping, changing redundancy levels, moving virtual disks between storage systems) with no server downtime and little if any user decisions.

In FIG. 5, a storage management configurator 500 is shown to include a processor 510 and memory 520. The processor controls and processes data for the storage management configurator 500. The process illustrated with reference to FIGS. 1-4 may be tangibly embodied in a computer-readable medium or carrier, e.g. one or more of the fixed and/or removable data storage devices 588 illustrated in FIG. 5, or other data storage or data communications devices. The computer program 590 may be loaded into memory 520 to configure the processor 510 for execution. The computer program 590 include instructions which, when read and executed by a processor 510 of FIG. 5 causes the processor 510 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for providing closed-loop management and control for a storage system, comprising:
monitoring at least one storage cluster for adherence to predetermined objectives; and
controlling virtual disks and virtual links associated with the at least one storage cluster in response to the monitoring.

2. The method of claim 1 further comprises masking the at least one physical storage cluster.

3. The method of claim 2, wherein the masking further comprises providing a virtual view into the at least one storage cluster to facilitate management and modification to storage configurations.

4. The method of claim 3 wherein the providing a virtual view into the cluster comprises providing performance and configuration information to the user.

5. The method of claim 1, wherein the monitoring at least one storage cluster for adherence to predetermined objectives further comprises monitoring at least one storage cluster for adherence to initial objectives supplied by a user.

6. The method of claim 5, wherein the monitoring at least one storage cluster for adherence to initial objectives further comprises monitoring at least one storage cluster for adherence to initial objectives defining a desired storage configuration.

7. The method of claim 1, wherein the monitoring further comprises verifying operations of the at least one storage cluster to modify a configuration of the at least one storage cluster.

8. The method of claim 1, wherein the monitoring enables the user to be removed from configuring the storage systems.

9. The method of claim 1, wherein the monitoring further comprises observing data usage patterns and performance rules to induce dynamic re-adjustment.

10. The method of claim 1, wherein the monitoring further comprises identifying characteristic parameters for physical disks in the storage clusters.

11. The method of claim 1, wherein the monitoring further comprises measuring system performance including total throughput and bandwidth, CPU utilization and bus utilization.

12. The method of claim 1, wherein the controlling virtual disks and virtual links further comprises creating, expanding, deleting and prioritizing physical storage.

13. The method of claim 1 further comprises classifying physical disks of the at least one storage cluster into characterized pools and characterizing higher level abstractions for defining the performance of virtual disks that are striped over the pools.

14. The method of claim 1, wherein the controlling further comprises prioritizing a first virtual disk over a second virtual disk.

15. The method of claim 1, wherein the controlling further comprises providing a selection of RAID types and stripe sizes and mirror depths and styles to achieve performance gradients within a specific pool.

16. The method of claim 1, wherein the controlling further comprises dynamically changing RAID characteristics.

17. The method of claim 1, wherein the controlling further comprises pausing mirroring and performing load balancing.

18. The method of claim 1, wherein the monitoring further comprises using the objectives and a knowledge of current operational dynamics of the at least one storage cluster to automatically create at least one virtual disk.

19. The method of claim 1, wherein the monitoring further comprises at least one process selected from the group comprising:
determining whether virtual disk dynamics match a desired storage system utilization;
reporting system configuration update information to the user;
gathering system data and storing the gathered data in a database; and
computing statistics on the virtual disks;

20. The method of claim 1, wherein the monitoring and controlling includes weighting of the objectives to allow preferences to be used when making automatic calculations.

21. The method of claim 1, wherein the controlling further comprises making change to configuration and providing information regarding configuration and control changes.

22. The method of claim 1, wherein the controlling further comprises changing RAID levels.

23. The method of claim 1, wherein the controlling further comprises increasing capacity across the at least one storage cluster.

24. A closed-loop storage system, comprising:
an interface for providing a virtual view into at least one storage cluster to facilitate management and modification to configurations of the at least one storage cluster;
a monitoring and feedback device, coupled to the interface, for monitoring the at least one storage cluster for adherence to predetermined objectives; and
a configuration and control device, coupled to the monitoring and feedback device, for controlling virtual disks and virtual links associated with the at least one storage cluster in response to input from the monitoring and feedback device.

25. The storage system of claim 24, wherein the mask provides performance and configuration information for use by a user.

26. The storage system of claim 24, wherein the monitoring and feedback device monitors the at least one storage cluster for adherence to initial objectives supplied by a user.

27. The storage system of claim 26, wherein the initial objectives defines a desired storage configuration.

28. The storage system of claim 24, wherein the monitoring and feedback device modifies a configuration of the at least one storage cluster.

29. The storage system of claim 24, wherein the monitoring and feedback device enables the user to be removed from configuring the storage systems.

30. The storage system of claim 24, wherein the monitoring and feedback device observes data usage patterns and performance rules to induce dynamic re-adjustment.

31. The storage system of claim 24, wherein the monitoring and feedback device identifies characteristic parameters for physical disks in the storage clusters.

32. The storage system of claim 24, wherein the monitoring and feedback device measures system performance including total throughput and bandwidth, CPU utilization and bus utilization.

33. The storage system of claim 24, wherein the configuration and control device creates, expands, deletes and prioritizes physical storage.

34. The storage system of claim 24, wherein the mask classifies physical disks of the at least one storage cluster into characterized pools and characterizes higher level abstractions for defining the performance of virtual disks that are striped over the pools.

35. The storage system of claim 24, wherein the configuration and control device prioritizes a first virtual disk over a second virtual disk.

36. The storage system of claim 24, wherein the configuration and control device provides a selection of RAID types and stripe sizes and mirror depths and styles to achieve performance gradients within a specific pool.

37. The storage system of claim 24, wherein the configuration and control device dynamically changes RAID characteristics.

38. The storage system of claim 24, wherein the configuration and control device pauses mirroring and performs load balancing.

39. The storage system of claim 24, wherein the monitoring and feedback device uses the objectives and a knowledge of current operational dynamics of the at least one storage cluster to automatically create at least one virtual disk.

40. The storage system of claim 24, wherein the monitoring and feedback device determines whether virtual disk dynamics match a desired storage system utilization, reports system configuration update information to the user, gathers system data, stores the gathered data in a database and computes statistics on the virtual disks;

41. The storage system of claim 24, wherein the monitoring and feedback device and the configuration and control device provide weighting of the objectives to allow preferences to be used when making automatic calculations.

42. The storage system of claim 24, wherein the configuration and control device makes changes to configuration of the at least one storage cluster and provides information regarding configuration and control changes to the monitoring and feedback device.

43. The storage system of claim 24, wherein the configuration and control device changes RAID levels within the at least one storage controller.

44. The storage system of claim 24, wherein the controlling further comprises increasing capacity across the at least one storage cluster.

45. A program storage device, comprising:
program instructions executable by a processing device to perform operations for providing a closed-loop storage system, the operations comprising:
monitoring at least one storage cluster for adherence to predetermined objectives; and
controlling virtual disks and virtual links associated with the at least one storage cluster in response to the monitoring.

46. The program storage device of claim 45 further comprises masking the at least one physical storage cluster.

47. The program storage device of claim 46, wherein the masking further comprises providing a virtual view into the at least one storage cluster to facilitate management and modification to storage configurations.

48. The program storage device of claim 47, wherein the providing a virtual view into the cluster comprises providing performance and configuration information to the user.

49. The program storage device of claim 45, wherein the monitoring at least one storage cluster for adherence to predetermined objectives further comprises monitoring at least one storage cluster for adherence to initial objectives supplied by a user.

50. The program storage device of claim 49, wherein the monitoring at least one storage cluster for adherence to initial objectives further comprises monitoring at least one storage cluster for adherence to initial objectives defining a desired storage configuration.

51. The program storage device of claim 45, wherein the monitoring further comprises verifying operations of the at least one storage cluster to modify a configuration of the at least one storage cluster.

52. The program storage device of claim 45, wherein the monitoring enables the user to be removed from configuring the storage systems.

53. The program storage device of claim 45, wherein the monitoring further comprises observing data usage patterns and performance rules to induce dynamic re-adjustment.

54. The program storage device of claim 45, wherein the monitoring further comprises identifying characteristic parameters for physical disks in the storage clusters.

55. The program storage device of claim 45, wherein the monitoring further comprises measuring system performance including total throughput and bandwidth, CPU utilization and bus utilization.

56. The program storage device of claim 45, wherein the controlling virtual disks and virtual links further comprises creating, expanding, deleting and prioritizing physical storage.

57. The program storage device of claim 45 further comprises classifying physical disks of the at least one storage cluster into characterized pools and characterizing higher level abstractions for defining the performance of virtual disks that are striped over the pools.

58. The program storage device of claim 45, wherein the controlling further comprises prioritizing a first virtual disk over a second virtual disk.

59. The program storage device of claim 45, wherein the controlling further comprises providing a selection of RAID types and stripe sizes and mirror depths and styles to achieve performance gradients within a specific pool.

60. The program storage device of claim 45, wherein the controlling further comprises dynamically changing RAID characteristics.

61. The program storage device of claim 45, wherein the controlling further comprises pausing mirroring and performing load balancing.

62. The program storage device of claim 45, wherein the monitoring further comprises using the objectives and a knowledge of current operational dynamics of the at least one storage cluster to automatically create at least one virtual disk.

63. The program storage device of claim 45, wherein the monitoring further comprises at least one process selected from the group comprising:
determining whether virtual disk dynamics match a desired storage system utilization;
reporting system configuration update information to the user;
gathering system data and storing the gathered data in a database; and
computing statistics on the virtual disks;

64. The program storage device of claim 45, wherein the monitoring and controlling includes weighting of the objectives to allow preferences to be used when making automatic calculations.

65. The program storage device of claim 45, wherein the controlling further comprises making change to configuration and providing information regarding configuration and control changes.

66. The program storage device of claim 45, wherein the controlling further comprises changing RAID levels.

67. The program storage device of claim 45, wherein the controlling further comprises increasing capacity across the at least one storage cluster.

68. A closed-loop storage system, comprising:
means for providing a virtual view into at least one storage cluster to facilitate management and modification to configurations of the at least one storage cluster;
means, coupled to the means for providing a virtual view, for monitoring the at least one storage cluster for adherence to predetermined objectives; and
means, coupled to the means for monitoring, for controlling virtual disks and virtual links associated with the at least one storage cluster in response to input from the monitoring and feedback device.
